(19) United States
(12) Patent Application Publication
(10) Pub. No.: US 2007/0032245 A1
(43) Pub. Date: Feb. 8, 2007

(54) Intelligent transportation system and method

(76) Inventor: Pertti O. Alapuranen, Deltona, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/240,846

(22) Filed: Sep. 30, 2005

Related U.S. Application Data
(63) Continuation of application No. 11/197,951, filed on Aug. 5, 2005.

(51) Int. Cl. H04Q 7/20

(52) U.S. Cl. 455/456.1; 370/328

(57) ABSTRACT

An intelligent transportation system and method employing ad-hoc multihopping wireless network technology. The system and method are capable of communicating travel condition information between vehicles (200), and employ a plurality of nodes (250), each adapted for communication in the multihopping network (100), and each being further adapted for deployment on a vehicle (200). Each of the nodes (250) operates to receive respective travel condition information pertaining to travel conditions relating to its respective vehicle (200), and transmits the respective travel information for receipt by other nodes (250).

### CROSS REFERENCE TO RELATED APPLICATION

Related subject matter is disclosed in co-pending U.S. patent application of John M. Belcea entitled “Autonomous Reference System and Method for Monitoring the Location and Movement of Objects,” Ser. No. 11/197,951, filed Aug. 5, 2005, the entire content of which is incorporated by reference herein.

### FIELD OF THE INVENTION

The present invention relates generally to an Intelligent Transportation System, and more particularly, to an Intelligent Transportation System employing ad-hoc multihopping wireless network technology.

### BACKGROUND

As known in the art, an Intelligent Transportation System (ITS) typically includes fixed infrastructure that senses and communicates road conditions to vehicle operators. For example, an ITS may include a plurality of sensors embedded in a road (e.g., weight sensors) for detecting the quantity and speed of vehicles traveling on the road to estimate travel times. Further, the ITS may employ adaptive highway signs and/or radio transmitter broadcasting on an amplitude modulation (AM) or frequency modulation (FM) channel for alerting vehicle operators in real time to congestion on the road ahead due to an accident or the like so the operators may detour their vehicles or otherwise take an appropriate action.

In the foregoing exemplary ITS, since communication between the ITS and the vehicle operators is a simplex mode (i.e., in one direction—from the ITS to a vehicle), one can appreciate that a known ITS is, disadvantageously, generally useful to a vehicle operator only in a passive role of providing information. Alternatively, in an active ITS having duplex communications between vehicles and the ITS, the ITS can assist the vehicle operators by facilitating vehicle features such as collision avoidance, adaptive cruise control (ACC), navigation and the like.

Adaptive cruise control (ACC) systems known in the art use information that is received from other vehicles and information from or about the road to control a vehicle's speed and distance from other proximate vehicles. For example, an ACC vehicle may detect the distances to nearby vehicles (e.g., by using infrared, ultrasonic, optical or other suitable sensing means), particularly a vehicle in front of the ACC vehicle, to determine an optimal steady state speed for the ACC vehicle. However, road curvature detection has been one of the technical problems not fully addressed by existing technologies for implementing ACC and collision avoidance systems.

Road property (e.g., road curvature) detection can be based on many principles, such as Global Positioning System (GPS)/map-based systems, vision-based systems and yaw rate-based systems. GPS/map-based systems are based on a GPS receiver measuring the location (i.e., latitude and longitude coordinates) of a vehicle, and comparing the vehicle's measured location within a stored map to get information about the road. GPS/map-based systems, however, typically do not work well in urban environments or in other locations where GPS information can not be received due to GPS signal interference from tall buildings, tunnels and other obstacles. Also, maintaining updated and accurate map information is time consuming due to permanent or temporary road construction, detours and the like that occur frequently and often without advance notice as the road network is maintained, repaired and/or developed.

Yaw rate-based systems employ gyroscopes or other kinematic sensors and can measure a change in the heading of a vehicle. Yaw rate-based systems, however, are not generally useful for vehicle ACC, navigation and collision avoidance systems since yaw rate-based systems cannot anticipate a future change (e.g., a curve and/or banked curve) in the road for adapting the vehicle's speed and direction to the change.

Vision-based systems require reference points, for example, lane markings or similar, to track a change (e.g., curvature) in a road. Vision-based systems, in this regard, require a “line of sight” and do not work well under certain weather conditions, such as during precipitation conditions (e.g., rain, sleet, or snow) or during winter conditions when the road surface is covered with ice or snow. Moreover, vision-based systems require upkeep and calibration of an optical interface (e.g., photodetectors and lenses) for maintaining the line of sight between the reference points on the road and the vehicle, which may be difficult and/or costly. Alternatively, radar can be used to detect other vehicles. Radar-based systems, however, face similar problems as faced by vision-based systems. For example; the radome has to be clean, and moreover, interpretation of the acquired range data describing the environment can often be demanding.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example of an ad-hoc multihopping wireless communications network according to an embodiment of the present invention;

FIG. 2 is a block diagram illustrating an example of a mobile node employed in the network shown in FIG. 1;

FIG. 3 is a diagram illustrating a portion of an example of an Intelligent Transportation System employing a network as shown in FIG. 1 according to an embodiment of the present invention;

FIG. 4 is a block diagram illustrating an example of a suitable vehicle for use in the Intelligent Transportation System shown in FIG. 3; and

FIG. 5 is a diagram illustrating an example of a process for determining absolute geographic location of a vehicle in the Intelligent Transportation System shown in FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an intelligent transportation system and method. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of an intelligent transportation system and method described herein. The non-processor circuits may include, but are not limited to, a radio receiver, a radio transmitter, signal drivers, clock circuits, power source circuits, and user input devices. As such, these functions may be interpreted as steps of a method to perform operations for providing an intelligent transportation system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As discussed in more detail below, the present invention provides an intelligent transportation system and method capable of anticipating travel conditions by a vehicle, such as a bicycle, automobile, train, boat, or any other type of vehicle. The system and method employ a first device which is adapted for deployment on a first vehicle and operable to communicate wirelessly with at least one second device. The first device receives information from at least one of the second devices which enables the first vehicle to anticipate travel conditions to be encountered by the first vehicle.

The system and method thus allow for the exchange of information between vehicles for detecting a road curvature, vehicle navigation and the like. A “road” can be any navigation path. Also, if available, a vehicle may receive location-specific supplemental navigation path information from a non-vehicle source such as a “smart road” element or other fixed information source (e.g., ITS infrastructure). In one exemplary embodiment, each of a plurality of vehicles is equipped with wireless communications capability, preferably, a multi-hop ad-hoc networking type of communications system that can be used to communicate information from one vehicle to other vehicles in the immediate vicinity. Thus, the communications between vehicles facilitate the sharing of vehicle and navigation path information to cooperatively anticipate the path curvature or other path properties. For example, a vehicle can obtain yaw rate sensor information, compasses, location information, and road curvature information from other proximate vehicles.

In addition, an active ITS could control a plurality of vehicles without intervention from the vehicles' operators. As one skilled in the art can appreciate, vehicles in an active ITS environment can include a transceiver and one or more sensors coupled to the transceiver for transmitting vehicle status information such as position, speed, acceleration and the like to the ITS. Exemplary vehicle sensors may include a position sensor (e.g., a GPS receiver), an accelerometer, an inclinometer and other sensors known in the art. To reliably communicate with a plurality of vehicles' transceivers, such an active ITS includes a plurality of fixed transceivers that are geographically distributed along one or more navigation paths. Antennas for each fixed ITS transceiver are generally mounted to a tower or path lighting structure, for example, and a communications backbone (e.g., optical fiber, microwave hops, etc.) is typically employed to interconnect the transceivers.

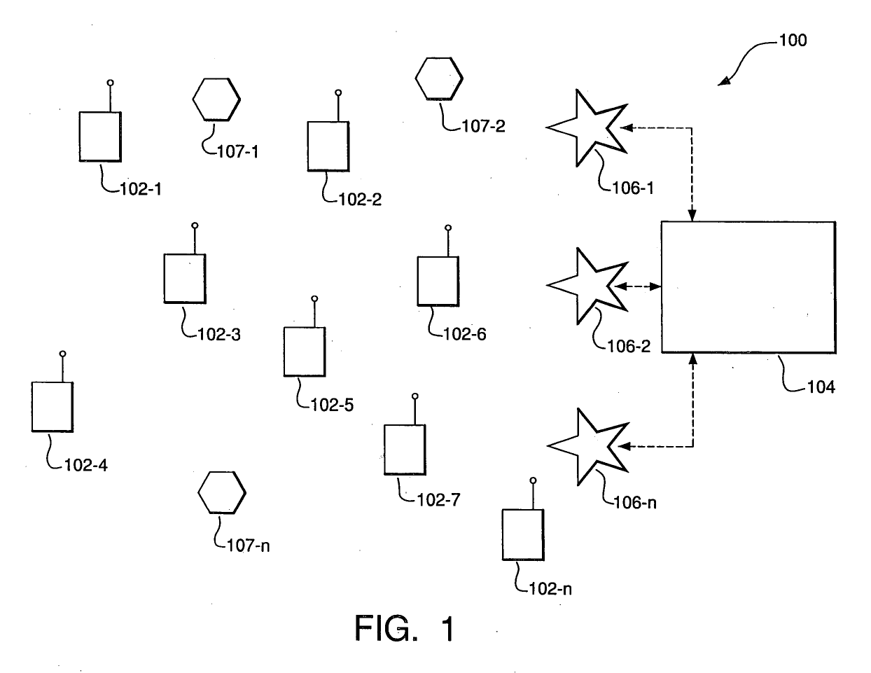

FIG. 1 is a block diagram illustrating an example of a wireless communications network 100, such as an ad-hoc packet switched multi-hopping network, employed in an exemplary embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. Pat. No. 5,943,322 to Mayor, and in U.S. patent application Ser. No. 09/897,790 and U.S. Pat. Nos. 6,807,165 and 6,873,839, all of which are incorporated by reference herein.

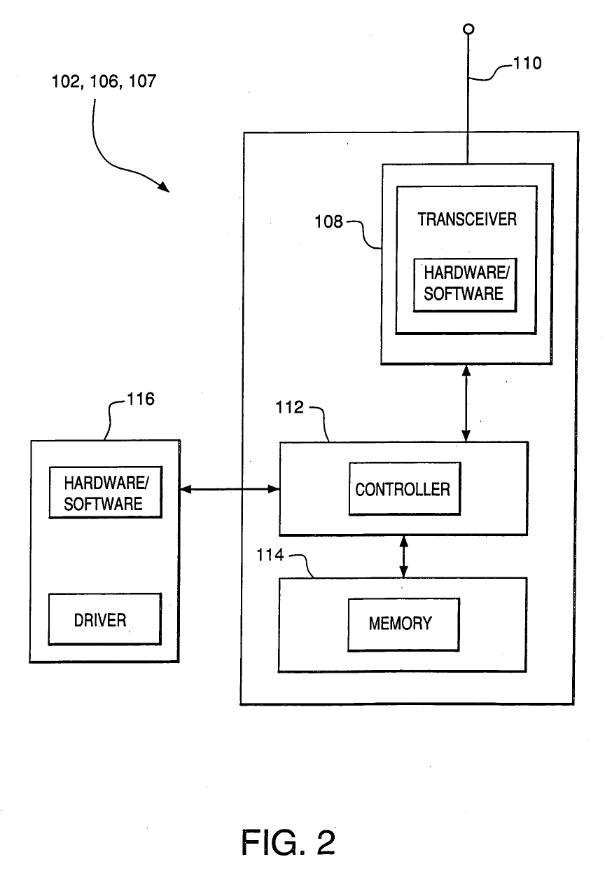

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

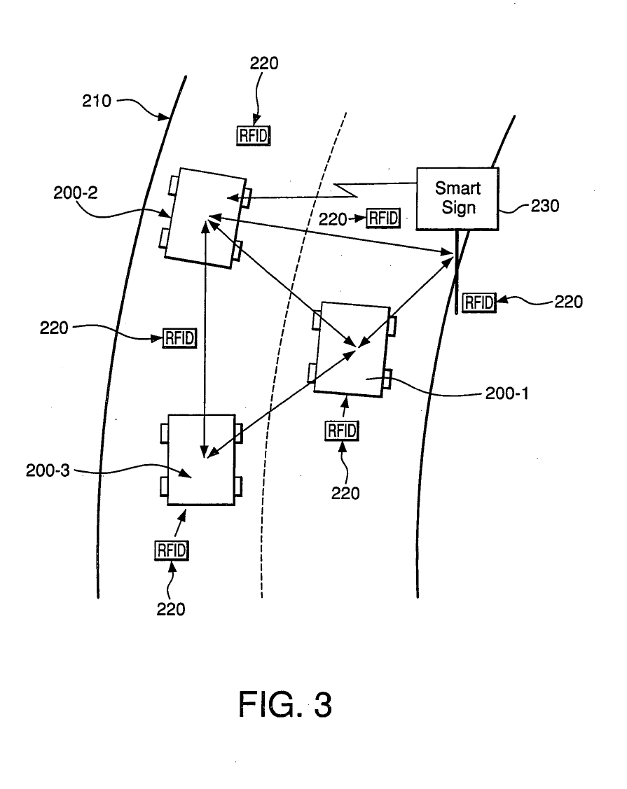

FIG. 3 illustrates an exemplary Intelligent Transportation System (ITS) incorporating the network 100 of FIG. 1 and nodes 102, 106, 107 in accordance with FIG. 2. As shown in this example, three vehicles 200-1, 200-2, and 200-3 (generally referred to as “vehicle 200”) are traveling proximate to each other on a road 210. It will be appreciated that any plurality of vehicles can be used in accordance with the embodiment of the present invention. Each of the vehicles 200-1, 200-2, and 200-3 includes a node (not shown) such as a mobile node 102 in accordance with FIGS. 1 and 2 so that the vehicles 200-1, 200-2, and 200-3 can communicate travel condition information (e.g., vehicle and/or road condition information) with each other. Further, the road 210 is illustrated as being a “smart road” that includes fixed infrastructure for communicating road information to the vehicles 200-1, 200-2, and 200-3. The smart road fixed infrastructure, in turn, is illustrated to include a plurality of radio frequency identification (RFID) transponders 220 (hereinafter referred to as RFID tags, or tags), which can be embedded in the surface of road 210, or otherwise affixed to or proximate to the road, and at least one smart sign 230. As known in the art, such RFID tags 220 can be read only, passive devices that are durable and maintenance free, requiring no power source such as batteries for operation and being able to retain data for many years. To this end, each tag 220 includes programmed data that a vehicle 200 can receive when proximate to the tag 220. For example, the programmed data for each tag 220 may be the geographic or physical location of the tag 220 (e.g., in latitude/longitude) and the geographic or physical location of the next tag 220 so the vehicle can interpolate, project or adjust its heading and speed to anticipate the path and attributes of the road ahead.

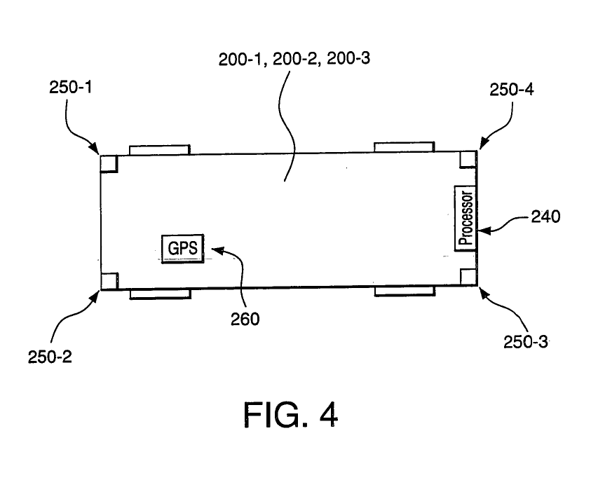

As shown in FIG. 4, each vehicle 200 includes an RFID tag reader processor 240 that receives a tag's programmed data, at least one antenna (not shown), and at least one communication means, such as a radio, that can comprise a node 102, for the purpose of determining the location of the vehicle 200 relative to another vehicle. As illustrated, the exemplary vehicle 200 includes four antennas and/or communication means 250-1, 250-2, 250-3, and 250-4 disposed proximate to the four corners of the vehicle 200. However, the antennas and/or communication means 250-1 through 250-4 may be disposed elsewhere, or fewer or additional in number as suitable. The communication means 250-1 through 250-4 communicates the received information to the tag reader processor 240. Alternatively, one or more of the communication means 250-1 through 250-4 can include the tag reader processor 240 or tag reading capabilities that can be performed, for example, by the controller 112 of the communication means. Also, as can be appreciated by one skilled in the art, a single communication means can be coupled to several antennas and be configured to distinguish the signals being received at the different antennas from each other. Further, since many modern vehicles are now available from the manufacturer with OEM navigation/map systems, the vehicle 200 may optionally be equipped with a GPS receiver 260 as shown for determining the vehicle's geographic location. Alternatively, if a vehicle does not include a GPS receiver 260 or other means for determining the vehicle's geographic location, the vehicle can determine its distance and/or relative location based on its distance to a proximate vehicle, tag 220 and/or smart sign 230 using any of a number of ranging techniques.

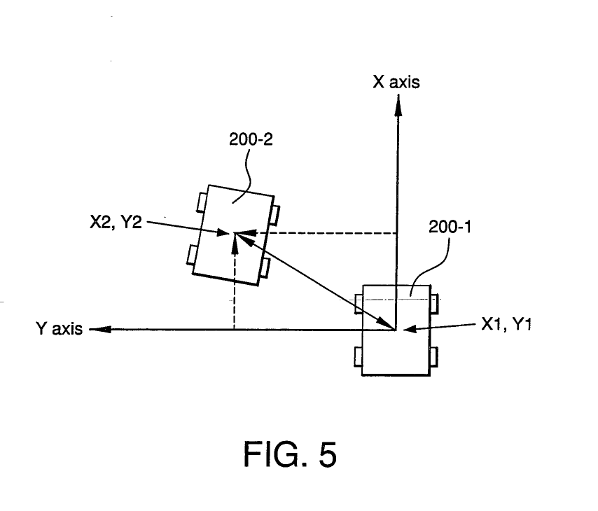

For example, referring now to FIG. 5, when a first vehicle 200-1 has knowledge of its geographic location X1, Y1 (such as, for example, because of the presence of a GPS receiver 260 at the first vehicle 200-1, through determination of its geographic location relative to a RFID tag 220 in the road 210), a second vehicle 200-2 which is proximate to the first vehicle 200-1 can then determine its own geographic location based on the location X1, Y1 of first vehicle 200-1 and communications between itself and the first vehicle 200-1, and other vehicles, tags 220 and/or smart signs 230. In particular, the second vehicle 200-2 can calculate or determine its geographic location X2, Y2 and the distance D separating the second vehicle 200-2 from the first vehicle 200-1, using any suitable algorithm known in the art (e.g., time difference of arrival (TDOA), angle of arrival (AOA), time of flight (TOF) and the like), such as those discussed in U.S. Pat. No. 6,728,545 and in published U.S. Patent Application Nos. 20030227895 and 20040005902, all of which are incorporated by reference herein.

The smart sign 230 may also include a display screen that provides information and/or alerts relative to the road 210, including, but not limited to travel times, traffic jams, detours and construction. Moreover, the smart sign 230 may include a transmitter or transceiver for transmitting information relative to the road 210 directly with the vehicles 200-1, 200-2, and 200-3 and for receiving vehicle information relative to each respective vehicle 200-1, 200-2, and 200-3. Vehicle information may include speed, acceleration, starting location, destination, desired route, and desired arrival time at the destination, as well as other data. As can be appreciated from FIG. 3, each vehicle 200-1, 200-2, and 200-3 may report or otherwise make available via the wireless network 100 vehicle and road information relative to at least that vehicle's instant location to the other vehicles. Suitable travel condition information (e.g., vehicle and road information) for use in the context of the present invention includes, for example, a relative location or distance from other vehicles (e.g., measured via Time of Flight (TOF) of communications signal) and other active items such as smart road information, smart bridge information, and traffic signs and traffic signals, and heading or its derivatives (e.g., speed, acceleration) from a location system (e.g., GPS). Other information can include information about road lanes from RFID tags 220 or other sensors embedded in the road or disposed on the side of the road.

The vehicles 200-1, 200-2, and 200-3 traveling along the lanes of road 210 can also provide the information to determine the curvature of the road from relative locations as each vehicle is traveling along the road 210. This is based on a calculation to create or interpolate a line which represents the roadway based on vehicles traveling in a single lane. This information can also be used to determine the number of lanes used at the measurement time based on locations of the vehicles relative to each other and their directions of travel relative to each other (i.e., moving in the same or different directions). A conventional smart road information system can inform vehicles about lanes, their widths, the number of lanes, their locations, any charge or toll associated to use the lanes and rules and regulations (i.e., restrictions such as High Occupancy Vehicle (HOV)) for using certain lanes.

A smart road information system can also communicate to a vehicle 200 the speed and other parameters that ACC or other systems can use to make traffic smooth and to avoid congestion. In one implementation of this method, a communications link is used by the vehicle's communication means (e.g., communication means 250-1) to read location-specific road information before the information is needed due to anticipate and negotiate a road curvature or a road property change (e.g., change of road surface material, elevation, bank angle or similar). The local information database can be stored to a smart sign 230 (FIG. 3) or other device that communicates with the vehicle 200 (e.g., a computer or server which hosts the database and is in communication with a radio broadcast transmitter). The location information can be from a GPS or any other location system. The basic principle is that local storage of road curvature and other parameters of the road are transmitted to a vehicle 200 and from one vehicle 200 to another using a wireless communication link. The information transmitted to a vehicle 200 can be the curvature of the road that can be used by collision avoidance or any other system in the vehicle 200. This information can be stored by a smart sign 230 or other vehicle 200 nearby that can then communicate this information to other vehicles that arrive at or pass by the location at a later time. The information can be also communicated directly to other vehicles 200. For example, the road curvature or lane information can be created statistically by analyzing raw data or information that is created by vehicles 200 passing by some location and this information can be stored by aggregating the information to some device close by (e.g., a smart sign 230). Alternatively, the location-specific (e.g., road curvature) information can be aggregated in a vehicle communication means 250 or distributed across several nodes in or otherwise proximate to the location of interest.

One can appreciate, in view of the foregoing, that Intelligent Transportation Systems employing smart road information can provide information to vehicles 200 using ad-hoc network links so that the vehicle 200 can use the information to control or influence its movement. In this way, for example, smart road information can help a vehicle operator by suggesting or directing the vehicle 200 into a particular or optimal lane based on a vehicle's properties and/or the vehicle's location-specific information (e.g., speed, weight, height, the destination, and so on).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A system for communicating travel condition information between vehicles, the system comprising:
a plurality of nodes, each adapted for communication in a multihopping network, and each being further adapted for deployment on a vehicle; and
each of the nodes being operable to receive respective travel condition information pertaining to travel conditions relating to its respective vehicle, and being further operable to transmit the respective travel information for receipt by other of the nodes.

2. A system as claimed in claim 1, wherein:
the respective travel condition information comprises information pertaining to operation of the vehicle on which the node is deployed.

3. A system as claimed in claim 2, wherein:
the information pertaining to the operation of the vehicle comprises information pertaining to at least one of the following: a location of the vehicle, speed of the vehicle, and acceleration of the vehicle.

4. A system as claimed in claim 1, wherein:
the respective travel condition information comprises information pertaining to physical surroundings of the vehicle on which the node is deployed.

5. A system as claimed in claim 4, wherein:
the information pertaining to the physical surroundings of the vehicle comprise information pertaining to a condition of a navigation path upon which the vehicle is traveling.

6. A system as claimed in claim 4, wherein:
the node is further adapted to obtain the information pertaining to physical surroundings of the vehicle from devices other than the nodes.

7. A system as claimed in claim 1, further comprising:
a plurality of devices, different from the nodes, and each being adapted to collect information pertaining to its physical surroundings; and
wherein at least one of the nodes is operable to receive the collected information from at least one of the devices as part of the respective travel condition information.

8. A system as claimed in claim 7, wherein:
at least one of the devices is a passive device, such that a node retrieves the collected information from a passive device by transmitting a signal to the passive device and receiving from the passive device a response signal containing the collected information.

9. A system as claimed in claim 1, wherein:
each of the nodes comprises a controller, adapted to provide a command based on the respective travel information to influence movement of the respective vehicle upon which its node is deployed.

10. A system as claimed in claim 1, wherein:
a plurality of nodes are deployed on the same vehicle, such that each of nodes is operable to receive different respective travel condition information pertaining to travel conditions relating to its respective vehicle.

11. A method for communicating travel condition information between vehicles, the method comprising:
deploying a plurality of nodes, each adapted for communication in a multihopping network, on a plurality of vehicles; and
operating at least one of the nodes to receive respective travel condition information pertaining to travel conditions relating to its respective vehicle; and
operating at least one of the nodes to transmit the respective travel information for receipt by other of the nodes.

12. A method as claimed in claim 11, wherein:
the respective travel condition information comprises information pertaining to operation of the vehicle on which the node is deployed.

13. A method as claimed in claim 12, wherein:
the information pertaining to the operation of the vehicle comprises information pertaining to at least one of the following: a location of the vehicle, speed of the vehicle, and acceleration of the vehicle.

14. A method as claimed in claim 11, wherein:
the respective travel condition information comprises information pertaining to physical surroundings of the vehicle on which the node is deployed.

15. A method as claimed in claim 14, wherein:
the information pertaining to the physical surroundings of the vehicle comprise information pertaining to a condition of a navigation path upon which the vehicle is traveling.

16. A method as claimed in claim 14, wherein:
the first operating step comprises operating the node to obtain the information pertaining to physical surroundings of the vehicle from devices other than the nodes.

17. A method as claimed in claim 11, further comprising:
deploying a plurality of devices, different from the nodes;
operating each of the devices to collect information pertaining to its physical surroundings; and
operating at least one of the nodes to receive the collected information from at least one of the devices as part of the respective travel condition information.

18. A method as claimed in claim 17, wherein:
at least one of the devices is a passive device; and
the method further comprises operating at least one of the nodes to transmit a signal to the passive device and receive from the passive device a response signal containing the collected information.

19. A method as claimed in claim 11, wherein:
each of the nodes comprises a controller; and
the method further comprises operating the controller to provide a command based on the respective travel information to influence movement of the respective vehicle upon which its node is deployed.

20. A method as claimed in claim 11, wherein:
a plurality of nodes are deployed on the same vehicle; and
the method further comprises operating each of nodes on a single vehicle to receive different respective travel condition information pertaining to travel conditions relating to its respective vehicle.
